(19) United States
(12) Patent Application Publication
(10) Pub. No.: US 2007/0131230 A1
(43) Pub. Date: Jun. 14, 2007

(54) Nasal adapter for the base of the nose

(75) Inventor: Marc Giroux, Lynnwood, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Kurve Technology, Inc., Bothell, WA (US)

(21) Appl. No.: 10/570,725

(22) PCT Filed: Sep. 7, 2004
(86) PCT No.: PCT/US04/28874

§ 371 Date: Feb. 8, 2007

Related U.S. Application Data
(60) Provisional application No. 60/500,469, filed on Sep. 5, 2003.

(51) Int. Cl. A62B 18/08; A62B 18/02

(52) U.S. Cl. 128/207.13; 128/206.24

(57) ABSTRACT

A novel nasal adapter is provided that conforms to, and seals with the base (underside) of a nose. Upward pressure exerted against the inventive nasal adapter compressibly conforms an adapter lip to seal with the underside of the nose. The nasal adapter provides for the comfortable, discreet, and effective transmission of deliverable flow (e.g., fluid, gas, airborne particles and medicament, etc.) to the nasal chambers with minimal leakage. In preferred embodiments, the nasal adapter is formed of a single molded piece made of flexible material and can be made in various sizes to adaptably conform to a broad range of nose sizes, and conformations. Particularly preferred embodiments comprise dual delivery channels with dual outflow apertures that are in communication with at least one lip that is proportioned and disposed to provide for separate delivery channels to each nostril.

### CROSS REFERENCE TO RELATED APPLICATIONS

This application claims the benefit of priority to U.S. Provisional Patent Application No. 60/500,469 entitled NASAL ADAPTER FOR THE BASE OF THE NOSE, filed 5 Sep. 2003 and incorporated by reference herein in its entirety.

### FIELD OF THE INVENTION

The present invention is directed to a novel apparatus that serves as a low resistance conduit for efficiently delivering airborne fluids, gases, and aerosolized particles and medicaments, etc., to the nasal cavity. In particular, the invention is directed to a nasal adapter that can be positioned to conform and seal to the base (underside) of a user's nose.

### BACKGROUND OF THE INVENTION

Nasal adapters for directing gas or particle streams to the nasal channels are known in the art, and are employed in both continuous and interval applications. Typically, such prior art nasal adapters substantially or completely cover the entire nose, or comprise tubes that cannulate the nasal channels to deliver fluids, gases or medicaments thereto. For nasal adapters to cover the nose substantially or completely, they must have a cavity that is larger than the size of the nose, and that essentially circumscribes the entire nose. Accordingly, such nasal adapters have a greater chance of air leaks, including leaks directed upwards into the eyes and are particularly disadvantageous. Moreover, the face-contacting portion of such adapters typically requires application of significant pressure to the wearer's face resulting in excessive discomfort and possibly skin irritation. The resultant nasal adapter is bulky, restrictive (e.g., interfering with glasses), and often difficult to completely seal around the nose, because of facial hair and/or extended, irregular or atypical surface contours. Furthermore such adapters are unsightly, and therefore undesirable for protracted or periodic use in public.

Prior art cannulable nasal adapters require insertion into the nostril and nasal channel, and therefore come into contact with the internal mucous membranes of the nose. Such adapters are associated with irritation and an elevated risk of infection, particularly when not adequately cleaned between uses.

There is, therefore, a pronounced need in the art for an effective, non-invasive nasal adapter, and particularly a non-invasive nasal adapter that can separately target each nostril.

There is a pronounced need in the art for a nasal adapter that is compact, portable and non-restrictive, easy to use, and that precludes leakage or improper delivery of airborne fluids, gases, and aerosolized particles and medicaments, etc.

There is a pronounced need in the art for a nasal adapter that provides a good conforming seal with the nose to improve the efficiency of fluid, gas, or medicament delivery thereto, and enhance comfort.

There is a pronounced need in the art for a nasal adapter that is discrete, allowing for suitable decorum in public use.

There is a pronounced need in the art for a device that is effective in providing an adequate conforming seal over a broad range of individual nose surface configurations.

These and other limitations and problems of the past are solved by the present invention.

### BRIEF SUMMARY OF THE INVENTION

A novel nasal adapter conforming to the base of the nose is disclosed and described herein. The inventive nasal adapter, in various aspects, provides a compact, portable, non-restrictive, non-invasive, easy to use device that provides a good conforming seal over a broad range of individual nose surface configurations to improve the efficiency of fluid, gas, or medicament delivery thereto, and to preclude leakage or improper delivery. The nasal adapter provides for user comfort and suitable decorum in public use.

Significantly, the inventive nasal adapter facilitates delivery of airborne particles to a user's nasal channels by providing for a temporary seal with the basal (underside) surface of the nose. Specifically, the adapter is sized and structured to conform to the basal surfaces of the nose, sealing around the nostrils (nares) allowing deliverable gas, fluid, or medicament to travel to the nasal chambers and beyond with minimal leakage.

In preferred embodiments, a lip, located on or integral with the outlet opening of the device comes into contact with the tissue tracing the contours of the basal surface of the nose. The outlet opening and lip comprise a generally horizontally planar and deformable surface that is placed in sealed communication with the basal surface of the nose by application of upward pressure to hold the adapter against the basal surface of the nose. The shape of the present invention is adaptable to a variety of different nose sizes and contours, and/or can be altered to fit noses of different sizes and contours.

Sealing of the opening outlet of the device and the surrounding lip to the basal surface of a user's nose is a significant aspect of the inventive device. This aspect eliminates the difficulties associated with prior art devices that cover or nearly cover the nose completely, or that are in contact with the internal mucous membranes of the nose. Additionally, in preferred dual delivery channel embodiments, the lip additionally sealably impinges on the columella nose base portion that runs between the nostrils, to provide for separate nostril delivery channels.

The inventive nasal adapter avoids the bulkiness of prior art devices covering the nose and the possibility of infections associated with devices that are inserted into the nostrils. The compact device allows for easy and comfortable communication with a small surface area of the nose to provide for relatively inconspicuous applications outside clinical settings.

The invention will best be understood by reference to the following detailed description of the preferred embodiment, taken in conjunction with the accompanying drawings. The discussion below is descriptive, illustrative and exemplary and is not to be taken as limiting the invention.

### BRIEF DESCRIPTION OF THE DRAWINGS

FIG. 1 contains several views of an exemplary embodiment of the inventive nasal adapter for the base of the nose. This embodiment has an optional vent means.

FIG. 2 is a perspective view of an exemplary embodiment of the inventive nasal adapter in use with a nebulizer.

FIG. 3 is an enlarged view of an exemplary embodiment of the inventive nasal adapter in use with a nebulizer, and shown sealed, by means of a conforming lip portion to the contour of the base (underside) of a user's nose.

FIG. 4 shows three views of a preferred embodiment of the inventive nasal adapter for the base of the nose. The nasal adapter comprises an adapter collar at the nasal distal aperture of its delivery channel. The collar is suitable to communicate with inflow sources, such as nebulizers and other aerosolized particle generating devices.

### DETAILED DESCRIPTION OF THE INVENTION

The basal surface of the nose, for purposes of the present invention, generally describes the underside of the nose, including the tissue surrounding the nostrils (nares) and extending to, and partially including the nasolabial junction. The basal surface generally extends from the lobule to about the nasolabial junction and captures the shape of the underside of the nose, including the alar areas (along the outside edges of the nostrils), and the columella area that extends between the nostrils from about the nasolabial junction to the infratip lobule.

Preferred aspects of the present invention provide a novel device for directing gases, fluids, aerosolized particles and medicament, and the like via the nostrils (nares) to the nasal channels. The adapter facilitates delivery of airborne particles, etc., to a user's nasal channels by providing for a temporary seal with the basal (underside) surface of the nose. Specifically, in preferred embodiments, the adapter outlet aperture and lip thereof comprise a generally horizontally planar and defonnable surface that is placed in sealed communication with the basal surface of the nose by application of upward pressure to hold the adapter lip against the basal surface of the nose. The nasal-proximal end of the adapter is sized and structured to conform to the basal surfaces of the nose, sealing around the nostrils (nares), and providing for directing of gas, fluid, aerosolized particles and medicament, and the like to nasal chambers and beyond with minimal leakage. The lip of the inventive adapter is comformable to, and substantially or completely positionable within the confines of the basal surface of the nose to non-obstructively encompass the nostrils, while providing a seal between the adapter and the basal surface of the nose to preclude escape of particles being administered through the device.

Preferably, the adapter is formed of a unitary piece of elastomeric material, comprising: an adapter chamber having an adapter wall with an external surface, and an internal surface that defines at least one delivery channel having a nasal-proximal inflow aperture for communicating with a basal surface of a nose, and a second, nasal-distal aperture generally opposite the nasal-proximal aperture for communicating with a deliverable source of inflow.

Preferably, the adapter comprises a generally planar deformable lip integral to, or in direct communication with the nasal-proximal aperture, the lip being conformable to the basal surface of a nose. Preferably, the lip covers from about the lobule to the alar base and may impinge on the nasolabial junction. The lip is sealable to the underside of the nose by application of upward pressure that collapses or compresses the lip along the contour of the underside of the nose.

Preferred dual delivery channel embodiments, comprise dual outflow apertures, and the lip is additionally suitably proportioned and disposed to be compressibly conformable and sealable to the columella nose base region that generally runs between the nostrils, and provide for separate nostril delivery channels. In such dual delivery channel embodiments, the lip may comprise two separate portions, each portion communicating with the circumference of a corresponding outflow aperture. Alternatively, the lip contour is unitary having two openings conforming to the dual output apertures. Dual delivery channel embodiments may also comprise corresponding dual nasal-distal inflow apertures.

In particularly preferred embodiments, the nasal-distal delivery channel aperture further comprises a adapter collar that is integral to, or in direct communication with the inflow aperture, and which is suitably proportioned and disposed to communicate with a source of deliverable inflow (airborne fluids, gases, and aerosolized particles and medicaments, etc.). Embodiments comprising more that one delivery channel may correspondingly comprise more than one inflow aperture, and in such cases the collar is proportioned and disposed to provide separate communication between each inflow aperture and a corresponding source flow channel.

In particular embodiments, the nasal adapter optionally comprises a vent aperture for communicating supplementary ambient air with the adapter delivery channel, or comprises an integral supplementary air channel or passage that directs supplemental air (e.g., along or within the adapter wall) to a position within or adjacent at least one delivery channel. Preferably, the supplemental air channel, if present, is integral to the adapter wall. Preferably, the vent is an inhalation vent. Alternatively, the vent is an exhaust vent or a two-way vent. In particular embodiments, the vent is U-shaped, however alternate shapes such as circular, rectangular, ovoid, etc are operative in the context of the inventive vent and nasal adapter.

A particular aspect provides a nasal adapter device for delivering particles to the nasal channels comprising; a cavity having a first and second opening generally opposite one another; an inlet opening for receiving airborne particles to be delivered; an outlet opening for delivering airborne particle from the device to the nasal chambers; a lip integral to the outlet opening suitable to create a seal between the device and the basal surface of the nose; a U-shaped vent along the outer surface of the cavity; and a collar allowing for communication with an external source of particles to be delivered.

Another aspect provides a nasal adapter comprising: a hollow body, a lip integral to one opening of the hollow body suitable to provide a seal with the basal surface of a nose; a vent allowing air particles to enter the hollow body; and a collar integral to a second opening of the hollow body so that the hollow body can securely attach to an external source that delivers predetermined particles through the second opening.

Yet another aspect of the invention provides a nasal adapter comprising: a hollow body, a generally planar deformable lip integral to one opening of the hollow body so that the lip is positionable to conform to and within the basal surface of the nose so as to non-obstructively encompass the nostrils while providing a seal between the lip and the basal surface of the nose to preclude escape of particles being administered through the device; a vent having a flexible flap integral to the outer surface of the hollow body so that supplementary air particles can enter the hollow body.

An additional aspect of the invention provides a nasal adapter comprising: an aerosolized fluid transporting channel with a top end opening and a bottom end opening, wherein the top end opening is positionable to conform to a basal surface of the nose and the bottom end opening is suitable to communicate with an external particle source to receive predetermined particles; a lip integral, or in direct communication with the top end opening, suitable to conformably seal with the base of a nose; and a collar communicable with an external particle source. A supplementary air vent may optionally be present to provide communication of ambient supplementary air with the delivery channel.

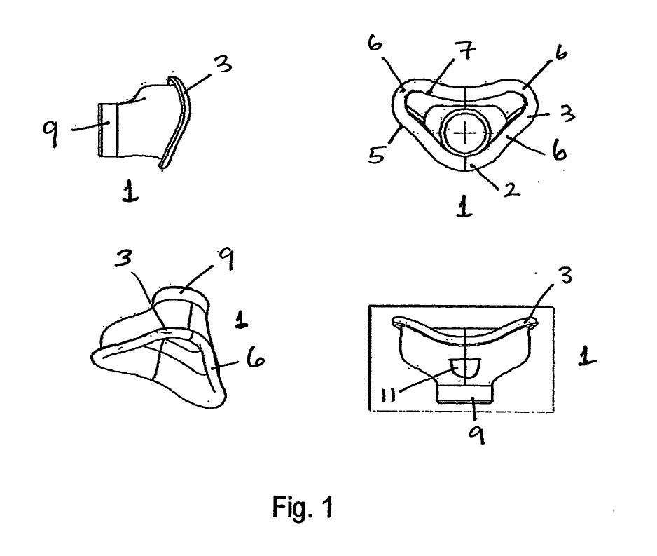

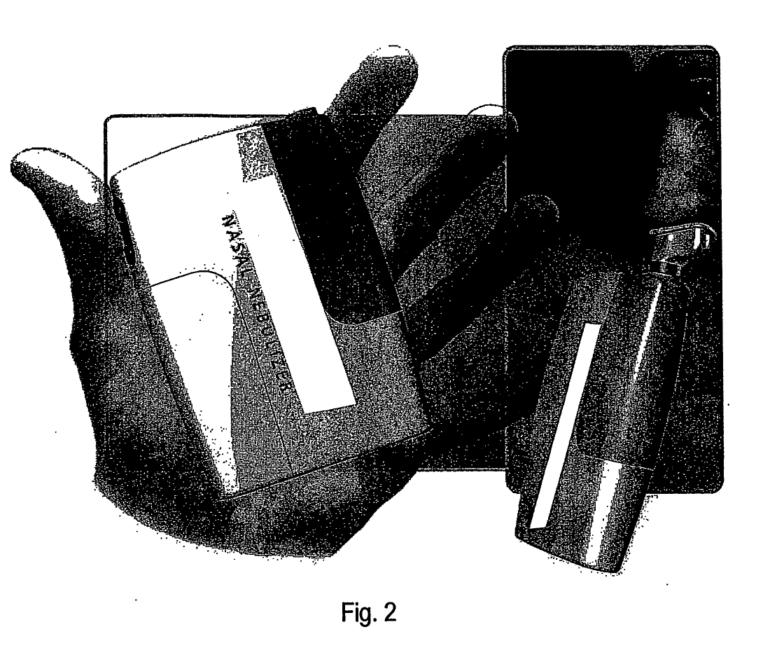

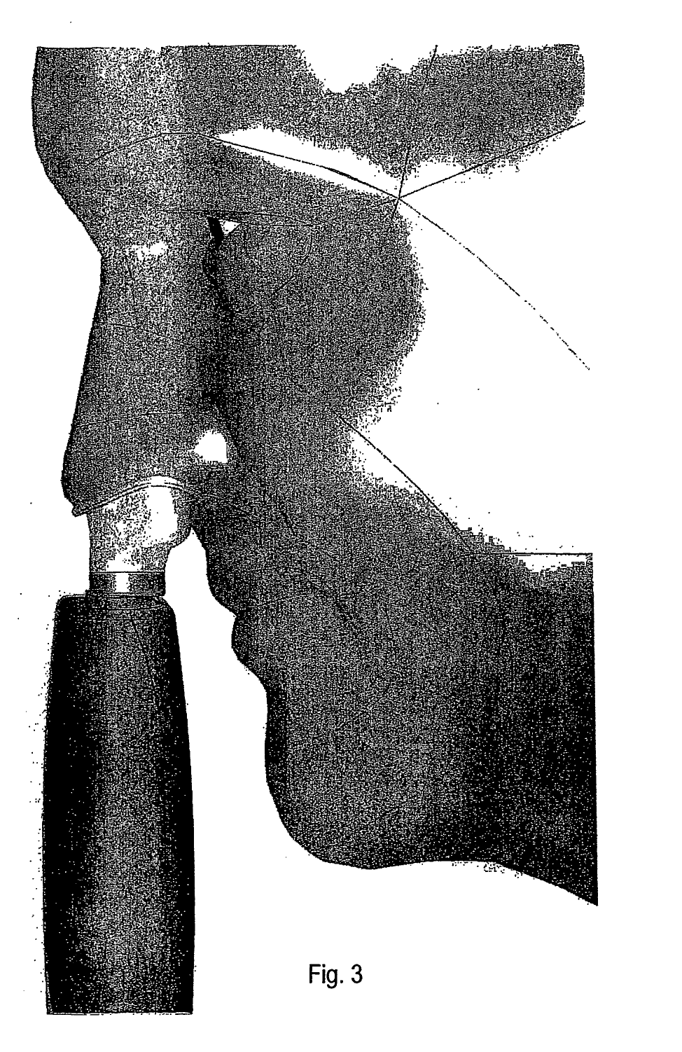

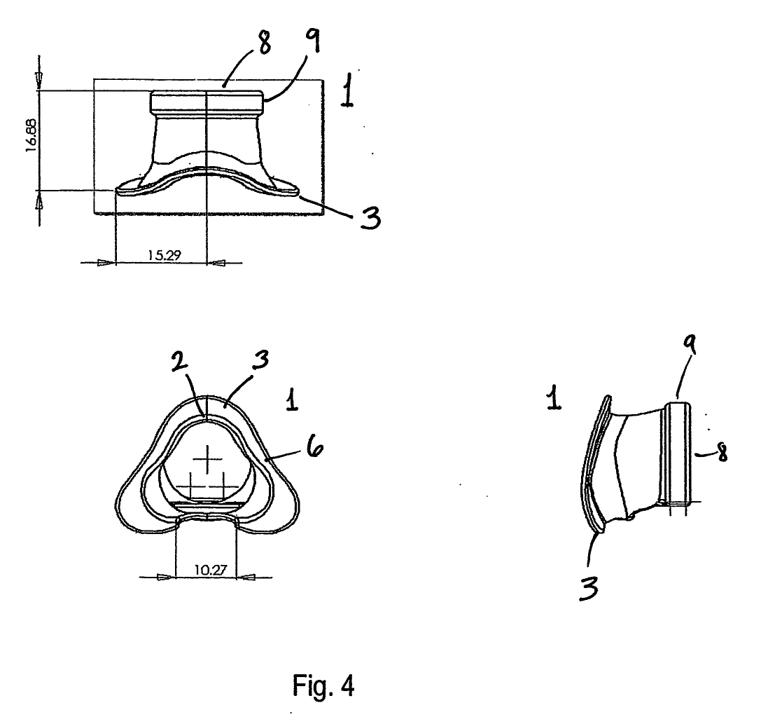

FIGS. 1-4 illustrate exemplary and preferred embodiments of the inventive nasal adapter for the base of the nose 1 according to the principles of the present invention.

Nasal adapter 1 includes a deformable lip 3 which contacts the basal surface (underside) of the user's nose, minimally including lobule contact points 2 and alar base contact points 6. Preferably, the lip covers from about the lobule to the alar base and may impinge on the nasolabial junction. The lip is sealable to the underside of the nose by application of upward pressure that collapses or compresses the lip along the contour of the underside of the nose. While the indicated contact points illustrate some of the specific regions impinged upon by the lip, the complete perimeter of the lip contacts and conforms with the contours of the basal surface of the nose to provide an effective seal. The lip my optional comprise, in dual delivery channel embodiments, an inter-aperture region proportioned and disposed to provide for conformably sealing with the columella region of the nose base that runs between the nostrils.

The nasal adapter 1 may optionally include an adapter collar 9 located at the inflow aperture opening 8. The collar 9 is capable of attachment to an external source of particles to be transmitted to the nasal channels.

The lip 3 has an inner diameter 7 and an outer diameter 5, and may deform slightly as pressure is applied upward and the lip comes into contact with the contours of the basal surface of the nose.

The nasal adapter 1 optionally includes a U-shaped flap 11 for communication of supplementary ambient air with adapter delivery channels.

The nasal adapter 1 is preferably an integral adapter, formed of a unitary piece of elastomeric material that is suitably flexible when a deformation force is applied thereto; yet returns to its original conformation when the deformation force is removed. The nasal adapter 1 is preferably made by molding a unitary shape. Alternatively, the inventive nasal adapter is a composite of portions (e.g., comprises a plurality of molded portions).

Therefore, preferred embodiments of the present invention provide a nasal adapter for the base of the nose, comprising: a adapter chamber comprising an adapter wall having an external surface, and an internal surface defining at least one nostril delivery channel, the delivery channel communicating between an inflow aperture in a nasal-distal end, and a generally opposed outflow aperture in a nasal-proximal adapter end; and at least one deformable lip integral to, or in direct communication with the circumference of the nasal-proximal aperture, the lip suitably proportioned and disposed to be compressibly conformable to a basal surface of a nose, and to non-obstructively encompass at least one nostril thereof while providing a seal between the adapter lip and the base of the nose.

Preferably, the lip is integral, generally disposed in a plane, and proportioned to seal against a basal nose surface extending from about the lobule to about the nasolabial junction and alar base. Preferably, the nasal adapter comprises dual nostril delivery channels each having a corresponding outflow aperture. Preferably the lip non-obstructively extends around the circumference of each of the dual outflow apertures, and is disposed to be additionally conformable to a columella nose base portion running between the nostrils, to provide for separate nostril delivery channels. Preferably, the nasal adapters comprising dual delivery channels, also comprise corresponding dual inflow apertures. Preferably, the nasal-distal inflow aperture is suitably proportioned and disposed to communicate with a source of deliverable inflow. Preferably, the nasal adapter further comprises a adapter collar that is integral to, or in direct communication with the inflow aperture, and which is suitably proportioned and disposed to communicate with a source of deliverable inflow.

Preferably, the nasal adapter comprises at least one of a supplementary air vent aperture and a supplementary air channel, to provide for communication of supplemental ambient air with the nostril delivery channel. Preferably, the supplementary air channel is integral to the adapter wall. The inventive nasal adapter may also comprise an exhaust vent aperture, and/or a two-way vent aperture.

In preferred embodiments, the source of deliverable inflow is selected from the group consisting of a nebulizer, a dispersion chamber of an integrated nebulizer and particle dispersion chamber, an atomizer, a spray bottle, and combinations thereof.

Additionally, combinations of the novel nasal adapter with at least one of a nebulizer, an integrated nebulizer and particle dispersion chamber (e.g., see WO03099359A1, incorporated by reference herein in its entirety), an atomizer, and a spray bottle are within the conceptive scope of the present invention.

No license is expressly or implicitly granted to any patent or patent applications referred to or incorporated herein. The discussion above is descriptive, illustrative and exemplary and is not to be taken as limiting the scope defined by any appended claims.

1. A nasal adapter for the base of the nose, comprising:
a adapter chamber comprising an adapter wall having an external surface, and an internal surface defining at least one nostril delivery channel, the delivery channel communicating between an inflow aperture in a nasal-distal end, and a generally opposed outflow aperture in a nasal-proximal adapter end; and
at least one deformable lip integral to, or in direct communication with the circumference of the nasal-proximal aperture, the lip suitably proportioned and disposed to be compressibly conformable to a basal surface of a nose, and to non-obstructively encompass at least one nostril thereof while providing a seal between the adapter lip and the base of the nose.

2. The nasal adapter of claim 1, wherein the lip is integral, generally disposed in a plane, and proportioned to seal against a basal nose surface extending from about the lobule to about the nasolabial junction and alar base.

3. The nasal adapter of claim 1, comprising dual nostril delivery channels each having a corresponding outflow aperture.

4. The nasal adapter of claim 3, wherein the lip non-obstructively extends around the circumference of each outflow aperture and is disposed to be additionally conformable to a columella nose base portion running between the nostrils, to provide for separate nostril delivery channels.

5. The nasal adapter of claim 3, comprising corresponding dual inflow apertures.

6. The nasal adapter of claim 1, wherein the nasal-distal inflow aperture is suitably proportioned and disposed to communicate with a source of deliverable inflow.

7. The nasal adapter of claim 6, further comprising a adapter collar that is integral to, or in direct communication with the inflow aperture, and which is suitably proportioned and disposed to communicate with a source of deliverable inflow.

8. The nasal adapter of claim 7, wherein the source of deliverable inflow is selected from the group consisting of a nebulizer, a dispersion chamber of an integrated nebulizer and particle dispersion chamber, an atomizer, a spray bottle, and combinations thereof.

9. The nasal adapter of claim 1, in combination with at least one of a nebulizer, an integrated nebulizer and particle dispersion chamber, an atomizer and a spray bottle.

10. The nasal adapter of claim 1, further comprising at least one of a supplementary air vent aperture and a supplementary air channel, to provide for communication of supplemental ambient air with the nostril delivery channel.

11. The nasal adapter of claim 10, wherein the supplementary air channel is integral to the adapter wall.

12. The nasal adapter of claim 1, further comprising an exhaust vent aperture.

13. The nasal adapter of claim 1, further comprising a two-way vent aperture.
